(19) United States
(12) Patent Application Publication
(10) Pub. No.: US 2022/0343949 A1
(43) Pub. Date: Oct. 27, 2022

(54) HARD DISK DRIVE HEAD SLIDER FOR SECONDARY ACTUATOR STROKE IMPROVEMENT

(71) Applicant: Western Digital Technologies, Inc., San Jose, CA (US)

(72) Inventors: Yuthana Punchanavanit, Pathum Thani (TH); Surachet Thammawong, Pathum Thani (TH); Pongsanat Kampeeraparpsuntorn, Pathum Thani (TH)

(21) Appl. No.: 17/239,431

(22) Filed: Apr. 23, 2021

(51) Int. Cl. G11B 21/21; G11B 5/48

(52) U.S. Cl. CPC G11B 21/21; G11B 5/4826

(57) ABSTRACT

A hard disk drive head slider is configured with a material void, such as a chamfer, positioned at a virtual intersection of a leading edge (LE) face and a suspension face. The material void provides for avoidance of structural interference between an actuator that is mechanically coupled with the slider and the suspension flexure during actuator operation, thereby enabling the actuator to achieve a full desired stroke.

### FIELD OF EMBODIMENTS

Embodiments of the invention may relate generally to hard disk drives, and particularly to approaches to improving the stroke of a secondary actuator.

### BACKGROUND

A hard disk drive (HDD) is a non-volatile storage device that is housed in a protective enclosure and stores digitally encoded data on one or more circular disks having magnetic surfaces. When an HDD is in operation, each magnetic-recording disk is rapidly rotated by a spindle system. Data is read from and written to a magnetic-recording disk using a read-write head (or “transducer”) that is positioned over a specific location of a disk by an actuator. A read-write head makes use of magnetic fields to write data to and read data from the surface of a magnetic-recording disk. A write head works by using the current flowing through its coil to produce a magnetic field. Electrical pulses are sent to the write head, with different patterns of positive and negative currents. The current in the coil of the write head produces a localized magnetic field across the gap between the head and the magnetic disk, which in turn magnetizes a small area on the recording medium.

Increasing areal density (a measure of the quantity of information bits that can be stored on a given area of disk surface) has led to the necessary development and implementation of secondary and even tertiary actuators for improved head positioning through relatively fine positioning, in addition to a primary voice coil motor (VCM) actuator which provides relatively coarse positioning. Some HDDs employ micro- or milli-actuator designs to provide second and/or third stage actuation of the recording head to enable more accurate positioning of the head relative to the recording tracks. Milli-actuators may be broadly classified as actuators that move the entire front end of the suspension: spring, load beam, flexure and slider, and are typically used as second stage actuators. Micro-actuators (or “microactuators”) may be broadly classified as actuators that move (e.g., rotate) only the slider, moving it relative to the suspension and load beam, or move only the read-write element relative to the slider body. A microactuator may be used solely in conjunction with a first stage actuator (e.g., VCM), or in conjunction with a first stage actuator and a second stage actuator (e.g., milli-actuator) for more accurate head positioning. The terms “microactuator” and “secondary actuator” and “dual stage actuator” are used herein to refer generally to a relatively fine-positioning actuator (e.g., technically, either secondary or tertiary) used in conjunction with a primary relatively coarse-positioning actuator, such as a VCM actuator in the context of an HDD. Piezoelectric (PZT) based and capacitive micro-machined transducers are two types of microactuators that have been developed for use with HDD sliders.

During manufacturing, an HDD undergoes a battery of operational and other tests including test(s) to measure the stroke (e.g., the distance displaced or the amount of rotation driven) of a microactuator sub-system, if applicable. If the operation of a microactuator is in some way impeded, then the sub-system may fail such a stroke test.

Any approaches that may be described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a plan view illustrating a hard disk drive, according to an embodiment;

FIG. 2A is a graph illustrating an actuator gain/stroke behavior corresponding to a normal arrangement, according to an embodiment;

FIG. 2B is a graph illustrating an actuator gain/stroke behavior corresponding to an abnormal arrangement, according to an embodiment;

FIG. 3 is a plan view, along with a magnified isometric view, illustrating a slider-suspension arrangement, according to an embodiment;

FIG. 4 is a side view illustrating a slider-suspension arrangement, according to an embodiment;

FIG. 5 is a side view illustrating a modified slider for actuator stroke improvement, according to an embodiment; and

FIG. 6 is a flow diagram illustrating a method of manufacturing a hard disk drive head slider, according to an embodiment.

### DETAILED DESCRIPTION

Generally, approaches to improving the stroke of a microactuator in a hard disk drive (HDD), are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices may be shown in block diagram form in order to avoid unnecessarily obscuring the embodiments of the invention described herein.

### Introduction

### Terminology

References herein to “an embodiment”, “one embodiment”, and the like, are intended to mean that the particular feature, structure, or characteristic being described is included in at least one embodiment of the invention. However, instances of such phrases do not necessarily all refer to the same embodiment,

The term “substantially” will be understood to describe a feature that is largely or nearly structured, configured, dimensioned, etc., but with which manufacturing tolerances and the like may in practice result in a situation in which the structure, configuration, dimension, etc. is not always or necessarily precisely as stated. For example, describing a structure as “substantially vertical” would assign that term its plain meaning, such that the sidewall is vertical for all practical purposes but may not be precisely at 90 degrees throughout.

While terms such as “optimal”, “optimize”, “minimal”, “minimize”, “maximal”, “maximize”, and the like may not have certain values associated therewith, if such terms are used herein the intent is that one of ordinary skill in the art would understand such terms to include affecting a value, parameter, metric, and the like in a beneficial direction consistent with the totality of this disclosure. For example, describing a value of something as “minimal” does not require that the value actually be equal to some theoretical minimum (e.g., zero), but should be understood in a practical sense in that a corresponding goal would be to move the value in a beneficial direction toward a theoretical minimum.

### Context

Recall that during HDD manufacturing, an HDD microactuator may undergo testing to measure the stroke, and if the operation of the microactuator is in some way impeded then the microactuator sub-system may fail the stroke test or other related sub-systems could consequently fail their related tests. One point of failure that has been observed corresponds to the effect that an uneven dispensing of the adhesive used to attach the slider to the suspension may have on the gap between the slider and the suspension at the slider leading edge (LE) side. For example, a normal gap may be on the order of 10 μm, whereas with undesired adhesive issues a zero or near zero gap may occur.

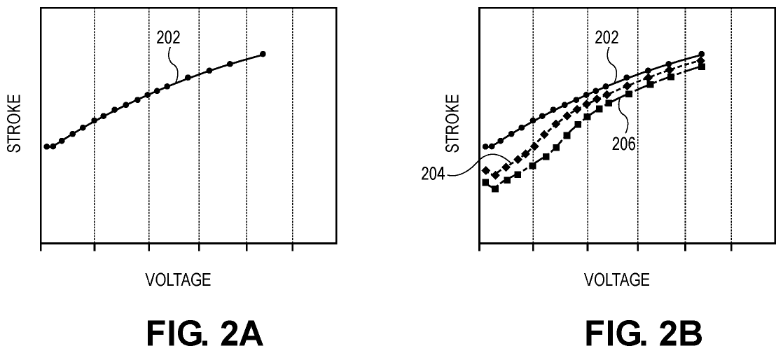

With an expected normal gap the microactuator stroke relative to voltage (i.e., the gain) is not dependent on the z-height of the slider-suspension assembly and, therefore, the servo system is able to generate the expected control. FIG. 2A is a graph illustrating an actuator gain/stroke behavior corresponding to a normal arrangement, according to an embodiment. FIG. 2A illustrates a series of data points, or a gain 202, that represents the output stroke of the actuator (y-axis) relative to the input voltage (x-axis) applied to the actuator, for what is considered and referred to as a “normal” arrangement in which a suitable gap between a leading edge (LE) of the slider and the suspension is present. The gain at various z-heights or flying heights of the slider are superimposed with the illustrated gain 202 (and thus not visible here), meaning that in this scenario the gain is not dependent on the z-height of the slider-suspension assembly and the assembly behaves as expected and, therefore, the servo system as designed is able to generate the expected control over the assembly.

By contrast, in the zero-gap scenario the microactuator stroke relative to voltage becomes dependent on the z-height of the slider-suspension assembly (e.g., due to the varying relative position and operation of the constituent parts, including the suspension flexure, at various flying heights) and the servo voltage control does not generate the desired slider motion, especially at lower voltages, because the actual assembly behaves differently than expected. FIG. 2B is a graph illustrating an actuator gain/stroke behavior corresponding to an abnormal arrangement, according to an embodiment. FIG. 2B illustrates multiple series of data points, i.e., gain 202, gain 204, and gain 206, which each represents the output stroke of the actuator (y-axis) relative to the input voltage (x-axis) applied to the actuator at a particular z-height, for what is considered and referred to as an “abnormal” arrangement in which a suitable gap between a leading edge (LE) of the slider and the suspension is not present, e.g., a zero-gap scenario. Here, the gain is dependent on the z-height of the slider-suspension assembly and the assembly often behaves differently from what is expected and, therefore, the servo system as designed is unable to generate the expected control over the assembly. Stated otherwise, the servo system is designed for gain 202, while the slider-suspension assembly at times behaves as exemplified by gain 204 and gain 206, depending on the corresponding z-height of the assembly. This phenomenon is found to be caused at least in part by slider LE interference with a portion of the suspension, generally, and with a portion of the flexure, particularly, at lower z-heights for example.

### Modified Head Slider for Interference Avoidance

An HDD includes at least one head gimbal assembly (HGA) that generally includes a slider that houses the read-write transducer (or “head”), and a suspension assembly. Each slider is attached to the free end of a suspension assembly that in turn is cantilevered from the rigid arm of an actuator. Several actuator arms may be combined to form a single movable unit, a head stack assembly (HSA), typically having a rotary pivotal bearing system. The suspension of a conventional HDD typically includes a relatively stiff load beam with a mount plate at its base end, which attaches to the actuator arm, and whose free end mounts a flexure that carries the slider and its read-write head. Positioned between the mount plate and the functional end of the load beam is a “hinge” that is compliant in the vertical bending direction (normal to the disk surface). The hinge enables the load beam to suspend and load the slider and the read-write head toward the spinning disk surface. It is then the function of the flexure to provide gimbaled support for the slider so that the slider can pitch and roll in order to adjust its orientation.

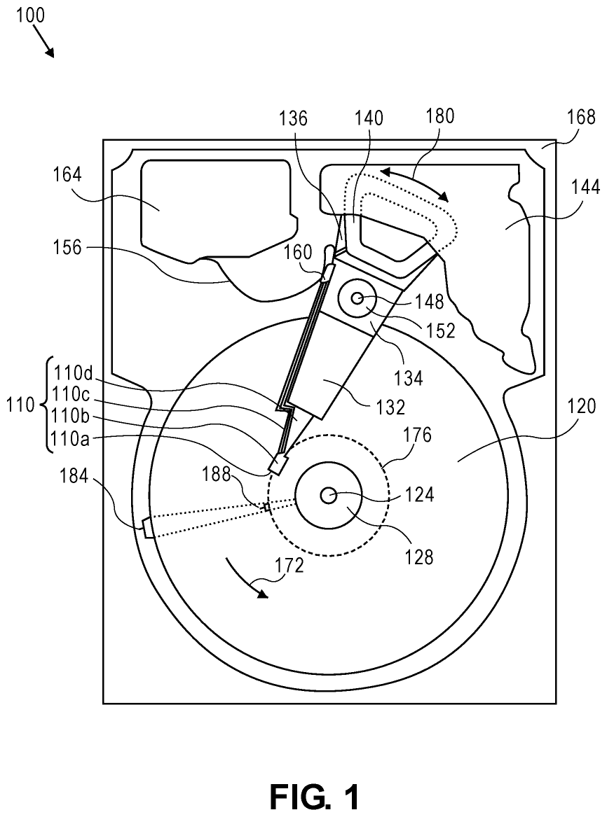

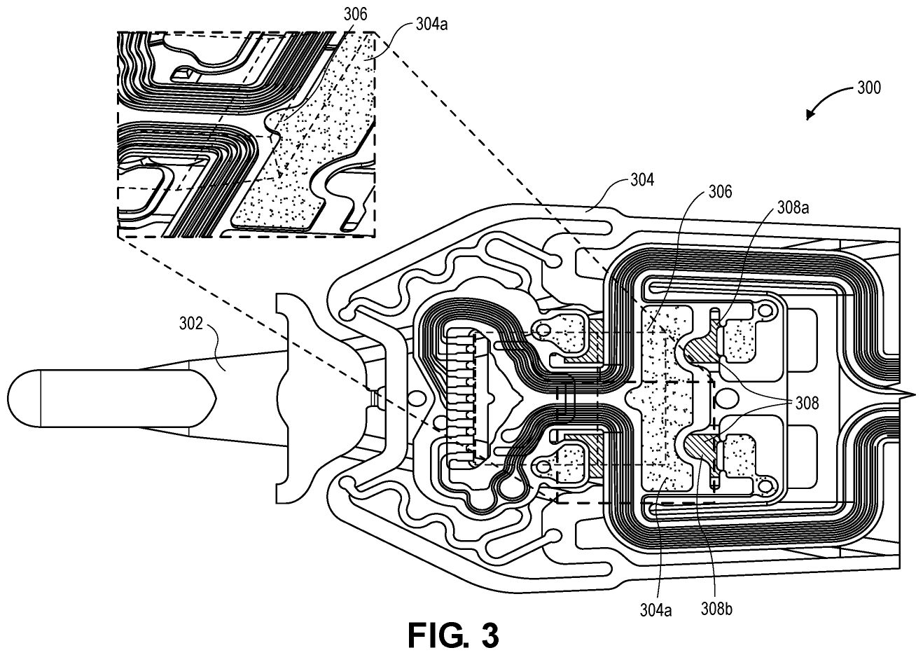

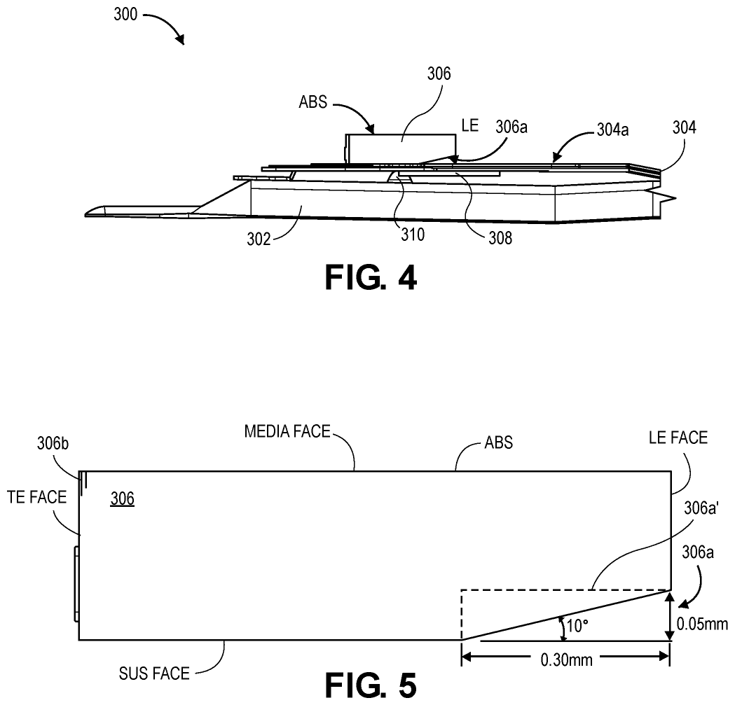

FIG. 3 is a plan view, along with a magnified isometric view, illustrating a slider-suspension arrangement, according to an embodiment. Assembly 300 is designed and configured for implementation into a hard disk drive (HDD) (see, e.g., FIG. 1), and comprises a suspension load beam 302 (or simply “load beam 302”), a suspension flexure 304 (or simply “flexure 304”) coupled with the load beam 302, a head slider 306 (shown here in dashed form to not obscure other components; e.g., see also FIG. 4) coupled with the flexure 304, and a microactuator (which may be part of a multi-stage actuation system such as “dual-stage” or “triple stage”) 308 comprising a pair of piezoelectric (PZT) devices 308a, 308b. The flexure 304 functions to provide gimbaled support for the head slider 306, via a gimbal 310 (FIG. 4), so that the slider 306 can pitch and roll in order to adjust its orientation when flying over a corresponding recording medium. In the context of a hard disk drive, a PZT microactuator is generally designed for rotating the head slider 306 by way of PZT motion. Here, the microactuator 308 is located at the flexure 304 and is positioned separately from but mechanically coupled with the head slider 306, and is utilized to drive the head slider 306 via the flexure 304 structure. When voltage is applied to the electrodes of the PZT devices 308a, 308b, an electric field causes the PZT to strain and, therefore, each PZT device 308a, 308b can contract or extend in its longitudinal direction by voltage applied to its electrodes.

According to an embodiment, the head slider 306 is adhesively mounted to the flexure 304. As discussed, an uneven dispensing or other undesired application of the adhesive used to attach a conventional head slider to the suspension may produce a zero or near zero gap between the slider and the suspension at the slider leading edge (LE) side. A portion of or a component 304a (e.g., a polyimide material) of the flexure 304 has been identified as mechanically interfering with the conventional slider, or at least with the adhesive used to mount the slider, at the LE side of the slider. Such interference can limit the movement of the microactuator 308 (i.e., the PZT devices 308a, 308b) underneath. According to an embodiment, the head slider 306 is constructed with a material void at its lower leading edge, as depicted in the magnified view of FIG. 3, thereby inhibiting or avoiding structural interference between the head slider 306 and the component 304a of the flexure 304. Hence, the microactuator 308 is allowed to operate with an unimpeded desired full stroke.

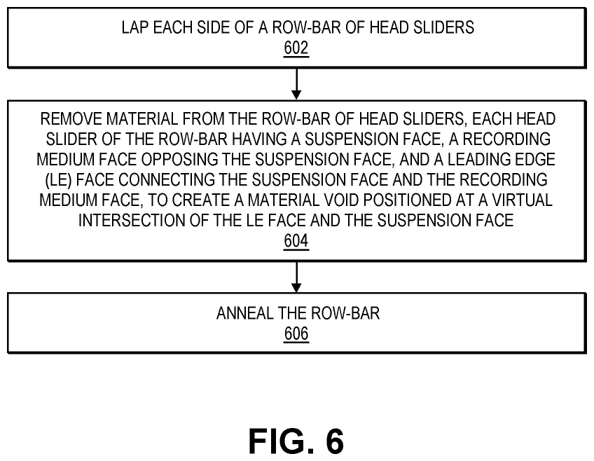

FIG. 4 is a side view illustrating a slider-suspension arrangement, according to an embodiment. Here again assembly 300 comprises the load beam 302, the flexure 304 coupled with the load beam 302, the head slider 306 coupled with the flexure 304 and gimbally-supported about the gimbal 310, and the microactuator 308. FIG. 5 is a side view illustrating a modified slider for actuator stroke improvement, according to an embodiment. As illustrated in FIG. 5, slider 306 has a leading edge (LE) face, a suspension (SUS) face, a recording medium (media) face opposing the SUS face, and a trailing edge (TE) face opposing the LE face of the slider 306 body where, generally, the TE face houses the read-write transducer 306b (or “read-write head 306b”). The media face is the face of the head slider 306 that faces the corresponding recording medium to which the read-write head 306b operationally interacts, and the SUS face is the face of the head slider 306 that faces the suspension 302 (FIGS. 3-4) comprising the flexure 304 (FIGS. 3-4) to which the head slider 306 is attached, adhered, or otherwise coupled. Slider 306 is depicted configured with a material void 306a, positioned at an (virtual) intersection of the LE face and the SUS face. According to an embodiment, the material void 306a is characterized or manifested by a removal of material from the slider body, such as at the slider row-bar phase of manufacturing as described in more detail elsewhere herein (FIG. 6). The material void 306a is configured to provide for avoidance of structural interference between the flexure 304 (FIGS. 3-4), namely the component 304a (FIGS. 3-4) of the flexure 304, and the head slider 306 during operation of the microactuator 308.

According to an embodiment, and as depicted in FIGS. 3-5, the material void is configured as a chamfer. While not limited to such dimensions, a 10-degrees (10°) chamfer manifesting the material void 306a and comprising a 0.30 millimeter (mm) by 0.05 mm material removal, is found suitable for the described purpose. However, the form of any material removal is highly design-dependent and, therefore, may vary from implementation to implementation. For example, a conceptual lower limit on suitable dimensions for the material void would correspond to a minimal amount of material that needs to be removed to avoid the unwanted interference between the flexure (or some other offending component in a different design scenario) and an abnormally-adhered slider in order to avoid jamming the microactuator, and a conceptual upper limit on material removal would correspond to an amount of removed material by which the slider mass distribution and/or flying dynamics are detrimentally affected beyond some suitable threshold (e.g., based on the specific slider shape, mass, ABS, and the like). According to an embodiment, the lateral width (e.g., the direction into the page of FIG. 5) of the slider 306 body corresponds to the width of the LE face, and the material void 306a runs along the entire lateral width of the slider 306. Other forms of the material void 306a are specifically contemplated and, therefore, fall within the scope of the described embodiments, such as a material void 306a manifested as a step or stepped structure, whereby a rectangular mass of material rather than a chamfer is removed at the LE-SUS faces such as depicted in dashed form as material void 306a′ in FIG. 5. However, a chamfer material void 306a is considered more readily or easily manufacturable than a step, based on a material removal step described in more detail elsewhere herein (FIG. 6).

Regarding possible effects the material void 306a could have on the flying characteristics or flying dynamics of the slider 306, any effect is considered manageable and relatively insignificant at least in part because the material removal 306a is positioned generally on the suspension 302 side of the head slider 306 rather than on the media, or air bearing surface (ABS), side of the slider 306. It is noted, however, that material void 306a does alter the mass distribution relative to a conventional head slider not having a material void 306a as described and illustrated herein. Some amount of mass removal is tolerable in the context of the flying dynamics of the head slider 306, therefore various material voids or removals may be implemented insofar as such removals do not exceed a change in slider 306 mass over a certain threshold. Limiting factors or constraints with respect to slider material removal are considered design-specific relative to a given head slider design. With respect to the head slider 306 of FIG. 5, the chamfer material void 306a is calculated to reduce the overall slider mass approximately 5%, well below a worst case 25% total mass change that is tolerable within the specific slider design control dimensions/tolerances. Thus, the illustrated slider 306 design is considered suitably effective in eliminating the likelihood of interference among the described components, while having a relatively trivial effect on the slider flying dynamics.

### Method of Manufacturing a Hard Disk Drive Head Slider

High volume magnetic thin film head slider fabrication involves high precision subtractive machining performed in discrete material removal steps. Slider processing starts with a completed thin film head wafer consisting of 40,000 or more devices, and is completed when all the devices are individuated and meet numerous and stringent specifications. A wafer comprises a matrix of unfinished head sliders having unfinished read-write transducers deposited on a substrate, for which AlTiC is commonly used. The matrix of sliders is typically processed in batches, i.e., subsets of the wafer, historically referred to as “quads” and now at times referred to as “chunks” or “blocks”. A block of unfinished head sliders comprises multiple rows (or “row-bars”) of unfinished head sliders. Each row comprises multiple head sliders. The individual devices ultimately become head sliders, housing a respective read-write head, for flying over a spinning disk.

A typical head slider fabrication process flow may include the following: a wafer fabrication process, which includes deposition of the reader and writer elements, followed by block (or “quad”) slicing to remove a block of unfinished sliders from the wafer. An outer row of sliders from the block may then be rough lapped (e.g., wedge angle lapped) in order to fabricate close to the desired reader and writer dimensions (e.g., flare point and stripe height), and then the outer rough-lapped row sliced from the block. From there, the row may be further lapped, such as “back-lapped” to form the flexure-side surface opposing the air bearing surface (ABS), and “fine-lapped” (or “final lapped”) to further refine the ABS surface. This then may lead to overcoating, and rail etching, etc. of the ABS surface to form the final air bearing or flying surface, at which point each head slider may be diced or parted from the row to individuate each finished head slider, whereby it can then be coupled with a flexure, assembled into a head-gimbal assembly (HGA), and so on.

FIG. 6 is a flow diagram illustrating a method of manufacturing a hard disk drive head slider, according to an embodiment. A head slider produced according to the method of FIG. 6 is designed, configured, intended for implementation into a hard disk drive (HDD) (see, e.g., FIG. 1). For context, each individuated head slider has what is referred to herein as a suspension face, a recording medium face opposing the suspension face, and a leading edge (LE) face connecting the suspension face and the recording medium face. Referring first to block 604, material is removed from a row-bar of head sliders to create a material void positioned at a virtual intersection of the LE face and the suspension face. For example, and according to an embodiment, a slider such as head slider 306 (FIGS. 3-5) is subject to edge grinding at the row-bar processing phase of slider fabrication, to create a material void 306a (FIGS. 4-5), such as a chamfer across the lateral width of the slider 306 at what would otherwise be the intersection of the LE face and the suspension face. It is noteworthy that the material void 306a forming involves the suspension face rather than the recording medium (or ABS) face, thereby avoiding a significant detrimental effect on the final slider 306 flying qualities. Alternatively, and according to an embodiment, a slider such as head slider 306 (FIGS. 3-5) is subject to a series of cutting procedures at the row-bar processing phase of slider fabrication, to create the material void 306a, such as a stepped structure (e.g., material void 306a′ of FIG. 5) across the lateral width of the slider 306 at what would otherwise be the intersection of the LE face and the suspension face.

In the context of the overall slider fabrication process, according to an embodiment the material removal procedure to create the material void 306 (i.e., at block 604) is performed after lapping each side of the row-bar, at block 602, and before annealing the row-bar, at block 606. While the described order of steps is found suitable within a relevant particular slider fabrication process, the order of such steps and where in the process the material removal is performed, may vary from implementation to implementation. Furthermore, rather than removing material to create the material void 306, the creation of the material void 306 could be implemented by a wafer/slider fabrication process in which slider material that would otherwise be present in a conventional slider lacking such a material void, is masked off and not deposited in the first place.

### Physical Description of an Illustrative Operating Context

Embodiments may be used in the context of a digital data storage device (DSD) such as a hard disk drive (HDD). Thus, in accordance with an embodiment, a plan view illustrating a conventional HDD 100 is shown in FIG. 1 to aid in describing how a conventional HDD typically operates.

FIG. 1 illustrates the functional arrangement of components of the HDD 100 including a slider 110b that includes a magnetic read-write head 110a. Collectively, slider 110b and head 110a may be referred to as a head slider. The HDD 100 includes at least one head gimbal assembly (HGA) 110 including the head slider, a lead suspension 110c attached to the head slider typically via a flexure, and a load beam 110d attached to the lead suspension 110c. The HDD 100 also includes at least one recording medium 120 rotatably mounted on a spindle 124 and a drive motor (not visible) attached to the spindle 124 for rotating the medium 120. The read-write head 110a, which may also be referred to as a transducer, includes a write element and a read element for respectively writing and reading information stored on the medium 120 of the HDD 100. The medium 120 or a plurality of disk media may be affixed to the spindle 124 with a disk clamp 128.

The HDD 100 further includes an arm 132 attached to the HGA 110, a carriage 134, a voice-coil motor (VCM) that includes an armature 136 including a voice coil 140 attached to the carriage 134 and a stator 144 including a voice-coil magnet (not visible). The armature 136 of the VCM is attached to the carriage 134 and is configured to move the arm 132 and the HGA 110 to access portions of the medium 120, all collectively mounted on a pivot shaft 148 with an interposed pivot bearing assembly 152. In the case of an HDD having multiple disks, the carriage 134 may be referred to as an “E-block,” or comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) and/or load beam to which the flexure is coupled, and an actuator (e.g., the VCM) to which the actuator arm is coupled, may be collectively referred to as a head-stack assembly (HSA). An HSA may, however, include more or fewer components than those described. For example, an HSA may refer to an assembly that further includes electrical interconnection components. Generally, an HSA is the assembly configured to move the head slider to access portions of the medium 120 for read and write operations.

With further reference to FIG. 1, electrical signals (e.g., current to the voice coil 140 of the VCM) comprising a write signal to and a read signal from the head 110a, are transmitted by a flexible cable assembly (FCA) 156 (or “flex cable”, or “flexible printed circuit” (FPC)). Interconnection between the flex cable 156 and the head 110a may include an arm-electronics (AE) module 160, which may have an on-board pre-amplifier for the read signal, as well as other read-channel and write-channel electronic components. The AE module 160 may be attached to the carriage 134 as shown. The flex cable 156 may be coupled to an electrical-connector block 164, which provides electrical communication, in some configurations, through an electrical feed-through provided by an HDD housing 168. The HDD housing 168 (or “enclosure base” or “baseplate” or simply “base”), in conjunction with an HDD cover, provides a semi-sealed (or hermetically sealed, in some configurations) protective enclosure for the information storage components of the HDD 100.

Other electronic components, including a disk controller and servo electronics including a digital-signal processor (DSP), provide electrical signals to the drive motor, the voice coil 140 of the VCM and the head 110a of the HGA 110. The electrical signal provided to the drive motor enables the drive motor to spin providing a torque to the spindle 124 which is in turn transmitted to the medium 120 that is affixed to the spindle 124. As a result, the medium 120 spins in a direction 172. The spinning medium 120 creates a cushion of air that acts as an air-bearing on which the air-bearing surface (ABS) of the slider 110b rides so that the slider 110b flies above the surface of the medium 120 without making contact with a thin magnetic-recording layer in which information is recorded. Similarly in an HDD in which a lighter-than-air gas is utilized, such as helium for a non-limiting example, the spinning medium 120 creates a cushion of gas that acts as a gas or fluid bearing on which the slider 110b rides.

The electrical signal provided to the voice coil 140 of the VCM enables the head 110a of the HGA 110 to access a track 176 on which information is recorded. Thus, the armature 136 of the VCM swings through an arc 180, which enables the head 110a of the HGA 110 to access various tracks on the medium 120. Information is stored on the medium 120 in a plurality of radially nested tracks arranged in sectors on the medium 120, such as sector 184. Correspondingly, each track is composed of a plurality of sectored track portions (or “track sector”) such as sectored track portion 188. Each sectored track portion 188 may include recorded information, and a header containing error correction code information and a servo-burst-signal pattern, such as an ABCD-servo-burst-signal pattern, which is information that identifies the track 176. In accessing the track 176, the read element of the head 110a of the HGA 110 reads the servo-burst-signal pattern, which provides a position-error-signal (PES) to the servo electronics, which controls the electrical signal provided to the voice coil 140 of the VCM, thereby enabling the head 110a to follow the track 176. Upon finding the track 176 and identifying a particular sectored track portion 188, the head 110a either reads information from the track 176 or writes information to the track 176 depending on instructions received by the disk controller from an external agent, for example, a microprocessor of a computer system.

An HDD's electronic architecture comprises numerous electronic components for performing their respective functions for operation of an HDD, such as a hard disk controller (“HDC”), an interface controller, an arm electronics module, a data channel, a motor driver, a servo processor, buffer memory, etc. Two or more of such components may be combined on a single integrated circuit board referred to as a “system on a chip” (“SOC”). Several, if not all, of such electronic components are typically arranged on a printed circuit board that is coupled to the bottom side of an HDD, such as to HDD housing 168.

References herein to a hard disk drive, such as HDD 100 illustrated and described in reference to FIG. 1, may encompass an information storage device that is at times referred to as a “hybrid drive”. A hybrid drive refers generally to a storage device having functionality of both a traditional HDD (see, e.g., HDD 100) combined with solid-state storage device (SSD) using non-volatile memory, such as flash or other solid-state (e.g., integrated circuits) memory, which is electrically erasable and programmable. As operation, management and control of the different types of storage media typically differ, the solid-state portion of a hybrid drive may include its own corresponding controller functionality, which may be integrated into a single controller along with the HDD functionality. A hybrid drive may be architected and configured to operate and to utilize the solid-state portion in a number of ways, such as, for non-limiting examples, by using the solid-state memory as cache memory, for storing frequently-accessed data, for storing I/O intensive data, and the like. Further, a hybrid drive may be architected and configured essentially as two storage devices in a single enclosure, i.e., a traditional HDD and an SSD, with either one or multiple interfaces for host connection.

### Extensions and Alternatives

In the foregoing description, embodiments of the invention have been described with reference to numerous specific details that may vary from implementation to implementation. Therefore, various modifications and changes may be made thereto without departing from the broader spirit and scope of the embodiments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

In addition, in this description certain process steps may be set forth in a particular order, and alphabetic and alphanumeric labels may be used to identify certain steps. Unless specifically stated in the description, embodiments are not necessarily limited to any particular order of carrying out such steps. In particular, the labels are used merely for convenient identification of steps, and are not intended to specify or require a particular order of carrying out such steps.

1. An assembly comprising:
a head slider having a slider body having a leading edge (LE) face, a suspension face, and a recording medium face opposing the suspension face, wherein the slider houses a read-write transducer at or near a trailing edge (TE) face opposing the LE face of the slider body;
a suspension assembly comprising:
a load beam, and
a separate flexure coupled with the load beam and having a side to which the suspension face of the slider is adhered, the flexure comprising an underlying portion with which the LE face of the slider body overlaps;
an actuator mechanically coupled with the slider and positioned separately from and near the LE face of the slider and between the load beam on one side and the slider and flexure on an opposing side;
wherein the slider body is configured with a material void configured as a rectangular step and positioned at a virtual intersection of the LE face and the suspension face, providing for avoidance of structural interference between the underlying portion of the flexure and the slider during actuator operation.

2. (canceled)

3. (canceled)

4. (canceled)

5. The assembly of claim 1, wherein the material void is characterized by a removal of material from the slider body.

6. A hard disk drive comprising the assembly of claim 1.

7. A hard disk drive head slider comprising:
a slider body having a leading edge (LE) face, a suspension face, and a recording medium face opposing the suspension face, wherein the slider houses a read-write transducer at or near a trailing edge (TE) face opposing the LE face of the slider body;
wherein the slider body is configured with a rectangular material void positioned at a virtual intersection of the LE face and the suspension face and having perpendicularly-intersecting planar faces.

8. The head slider of claim 7, wherein:
a lateral width of the slider body corresponds to a width of the LE face; and
the slider body is configured such that the material void runs along the entire lateral width of the slider body.

9. A method of manufacturing a hard disk drive head slider, the method comprising:
removing material from a row-bar of head sliders, each head slider of the row-bar having a suspension face, a recording medium face opposing the suspension face, and a leading edge (LE) face connecting the suspension face and the recording medium face, to create a material void in a form of a rectangular step positioned at a virtual intersection of the LE face and the suspension face and having perpendicularly-intersecting planar faces.

10. The method of claim 9, further comprising:
lapping each side of the row-bar; and
annealing the row-bar;
wherein the removing is performed after the lapping and before the annealing.

11. The method of claim 9, wherein the removing comprises edge grinding the row-bar of head sliders to create the material void.

12. The method of claim 9, wherein the removing comprises cutting the row-bar of head sliders to create the rectangular step.

13. The method of claim 9, wherein each head slider of the row-bar houses a read-write transducer at or near the TE face of the slider.

14. A hard disk drive head slider produced according to the method of claim 9.
